(19) United States
(12) Patent Application Publication
(10) Pub. No.: US 2023/0385724 A1
(43) Pub. Date: Nov. 30, 2023

(54) AUTOFILL PARTIAL SHIFT

(71) Applicant: Siemens Healthcare GmbH, Erlangen (DE)

(72) Inventors: Egan Schulz, San Jose, CA (US); Robert Campoy, La Honda, CA (US); Mirko Buholzer, San Francisco, CA (US)

(21) Appl. No.: 17/664,878

(22) Filed: May 25, 2022

(51) Int. Cl. G06Q 10/06

(52) U.S. Cl. CPC G06Q 10/063112; G06Q 10/063116

(57) ABSTRACT

Embodiments provide a system and method for scheduling a shift. The system and method receive a shift request comprising a skill set and shift data. Based on the skill set, workers are identified who have the received skill set. The identified workers with the received skill set are ranked based on the shift data and assigned a rank. A shift request is sent to the highest ranked worker. An output to a user interface displays the identity of the highest ranked worker accepting the shift request.

### TECHNICAL FIELD

The present disclosure relates generally to the efficient editing of work schedules. More specifically, the invention is directed to systems and methods that enable a shift to be automatically filled by another worker and for creating a customized scheduling calendar.

### BACKGROUND

Employees typically manage their day using a conventional electronic calendar. The conventional electronic calendar generally presents an interface that allows a user to create an event at a specified time, such as a meeting, task or appointment. However, the conventional electronic calendar starts a new week with the same day of the week and that is typically a Sunday. This might not be flexible to some of the users as they might have a different day as the starting of the week. Additionally, conventional calendars generally display the schedule of the work for a day, week, month or a year. In other words, the users can only select the options provided by the conventional calendar to view their schedule. However, the conventional calendars fail to provide an option to the user to generate a customized view of say, for example, 2, 6, or 7 weeks of the schedule in the calendar.

Furthermore, in many industries, such as the service industry, workers are scheduled to work various shifts. Exemplary industries in which workers are scheduled for shifts include the food service industry, manufacturing, fire fighters, police, ambulance, nursing, and the like. Furthermore, workers may be trained, capable of, certified, etc., for more than one task for an employer, and as a result, some workers may perform a first task on one shift and a second task on another shift.

Conventionally, employers who hire workers for shifts provide the workers with a schedule that dictates when the workers are to work and even what responsibilities they may have during their scheduled shift. Conventionally, assembling these schedules may be time consuming because it is difficult to accommodate various shift requests and time off requests made by the workers. The difficulty in determining shifts is multiplied when the particular task requires workers with a very specific set of skills or certification. For example, a hospital may only be able to schedule a nurse to work in the emergency room (“ER”) if the nurse has passed a particular hospital's certification and is trained as an ER nurse.

As is common, from time to time, workers will need to shorten their shift at the last minute or swap their shift with someone else due to a variety of circumstances. For example, an auto assembly worker might get sick at work and need to go home half way through his shift. In this instance, the auto worker's supervisor may need to schedule a replacement worker. Conventionally, the scheduling of a replacement was done manually by contacting a list of other workers not currently scheduled to see if those workers could come in and fill in the remaining time on the auto worker's shift. This process is inefficient as it requires a manual lookup of workers qualified to perform the work and time contacting them to find someone who will take the remainder of the shift.

Other conventional solutions have addressed this problem by enabling other workers to work extra to make up for missing productivity of the worker who stops working. However, this may not be practical in all fields. For example, in nursing, patients cannot wait for the next shift of nurses. In the healthcare industry, if a nurse cannot complete a shift, then patient care may suffer, so there is a need to quickly find a replacement nurse who is qualified to finish the shift.

Finding replacement workers on short notice is not confined to incidents in which workers have unanticipated needs for time off such as when they or someone they care for (e.g., a child) falls ill or has an accident. Other incidents also demand fast and efficient replacement. Returning to the nursing example, a hospital might typically staff an emergency room with six nurses, but if there is a large influx of patients due to an emergency, the hospital will need to request additional help immediately. Conventionally, this entailed contacting the list of non-working nurses, for example by calling, emailing, or texting. This conventional solution is predicated on a notation or other pre-set knowledge of which nurses are qualified for the ER.

Other conventional ways of finding replacement workers include the worker contacting co-workers to fill in for them. For example, a worker may want a particular individual to take over the worker's shift, and so that worker may only contact this particular worker. A potential problem with this approach is that there may be other workers who would be more qualified, have more need for hours, or have other factors that would make them more suited to replace the worker. However, those workers will not have been contacted by the worker, and the worker's supervisor may not consider those other workers because the supervisor may not know the factors associated with the other workers that would make them better candidates without a lengthy review process. Even knowing those factors, a supervisor may not contact those workers because the selected replacement is ready to work and the supervisor has an expedient need to fill the shift.

### SUMMARY

Embodiments of the present invention address and overcome one or more of the above shortcomings and drawbacks, by providing methods, systems, and apparatuses related to autofill a partial work shift on short notice when the scheduled worker cannot work or complete the scheduled shift. The present invention comprises a graphical user interface (“GUI”) that enables a worker or supervisor to adjust the time worked during a shift. If the time worked is less than the scheduled time, then the present invention determines the most qualified worker who is available to complete the shift and contacts that worker to see if the worker will take the shift. The present invention improves the efficiency and accuracy by which replacement workers are identified.

Embodiments can provide a method for scheduling a shift, the method comprising receiving a shift request comprising a skill set and shift data; identifying workers based on the skill set; determining a ranking based on the shift data of the identified workers; assigning each identified worker a rank according to the ranking; sending the shift request to a highest ranked worker; and outputting to a user interface an identity of the highest ranked worker accepting the shift request.

Embodiments can further provide a method further comprising when the highest ranked worker declines the shift request, sending the shift request to a next highest ranked worker until the shift request is accepted.

Embodiments can further provide a method wherein the shift data comprises one or more of a location, a time, a date, and a duration.

Embodiments can further provide a method further comprising a graphical user interface displaying a graphical representation comprising shifts and shift requests.

Embodiments can further provide a method wherein the graphical representation is a linear slider manipulated by a user.

Embodiments can further provide a method wherein the shift request is received from a supervisor.

Embodiments can further provide a method wherein the shift request is received as a result of an original worker declining to work the shift in the shift request.

Embodiments can further provide a method further comprising determining the skill set for the shift from the original worker.

Embodiments can further provide a method further comprising determining the skill set for the shift from the shift data comprising one or more of a department, a certification, a license, a training, or a skill.

Embodiments can further provide a method wherein the identified workers comprise workers selected by a user.

In another illustrative embodiment, a non-transitory computer readable medium having stored thereon instructions for scheduling a shift, comprising executable code, which when executed by at least one processor, cause the processor to perform various ones of, and combinations of, the operations outlined above with regard to the method illustrative embodiment.

In yet another illustrative embodiment, a system is provided. The system may comprise a memory; a processor in communication with the memory; and program instructions executable by the processor via the memory to cause the processor to perform various ones of, and combinations of, the operations outlined above with regard to the method illustrative embodiment.

Additional features and advantages of this disclosure will be made apparent from the following detailed description of illustrative embodiments that proceeds with reference to the accompanying drawings.

### BRIEF DESCRIPTION OF THE DRAWINGS

The foregoing and other aspects of embodiments of the present invention are best understood from the following detailed description when read in connection with the accompanying drawings. For the purpose of illustrating the invention, there is shown in the drawings embodiments that are presently preferred, it being understood, however, that embodiments of the invention are not limited to the specific instrumentalities disclosed. Included in the drawings are the following Figures:

FIG. 1 is a block diagram of a network environment including an example of schedule management apparatus for creating a customized scheduling customized calendar;

FIG. 2 is an exemplary block diagram of the schedule management computing apparatus;

FIG. 3 is an exemplary flowchart of a method for creating a customized scheduling calendar;

FIG. 4 is an exemplary image of a form to create the customized scheduling calendar;

FIG. 5 is an exemplary diagram of the created customized scheduling calendar;

FIG. 6 is an exemplary image of the created customized scheduling calendar;

FIG. 7 is an exemplary image of a customized scheduling calendar displayed on a mobile device;

FIG. 8 is an exemplary image of the customized scheduling calendar displayed on a laptop;

FIG. 9 is a flow chart of an example of a method for shift scheduling according to embodiments described herein;

FIGS. 10A, 10B, and 10C depict exemplary diagrams of a graphical user interface (GUI) with a shift indicator according to embodiments described herein;

FIGS. 11A, 11B, 11C, and 11D depict exemplary diagrams of a GUI for replacing a shift according to embodiments described herein;

FIG. 12 depicts an exemplary diagram of a GUI calendar view according to embodiments described herein; and

FIG. 13 illustrates an exemplary computing environment within which the techniques described herein may be implemented.

### DETAILED DESCRIPTION

The following disclosure describes the present invention according to several embodiments directed at methods, systems, and apparatuses related to creating a customized scheduling calendar in a graphical user interface. More specifically, the techniques described herein allow the user to create a customizable calendar with a week starting on the day preferred by the user. Using these techniques, performance and efficiency of using graphical user interfaces is improved because there is no longer a need to use the conventional calendars that require the work week to always begin on a Sunday. Furthermore, the present invention relates generally to methods, systems, and apparatuses for automatically filling a work schedule at short notice with qualified workers who are available to work at the required time. More specifically, the techniques described herein solve the problems described above by identifying the pool of workers who are available to work at the required time, and then determining the best worker to do the work. There are a number of advantages to this approach. For example, when a work shift needs to be covered at short notice, time is of the essence to find replacements, and the techniques described herein identify the most qualified available worker(s) to fill the missing shift. Another advantage is the GUI interface that provides a convenient visual display for requesting replacements as well as visualizing the progress for finding the replacements. As another advantage, when a worker needs to shorten or delete a shift, then one or more replacement workers may need to be scheduled to cover for the absent worker. In some embodiments, the time that the worker misses may not need to be covered by other workers. A supervisor may make a determination based on the work load, time left on the shift, or other factors that no replacement or coverage for the missing worker is needed.

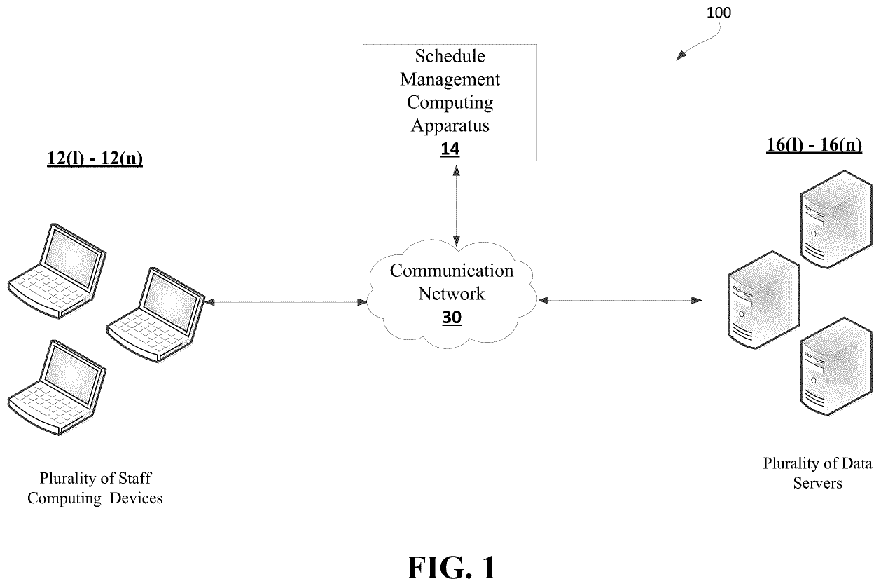

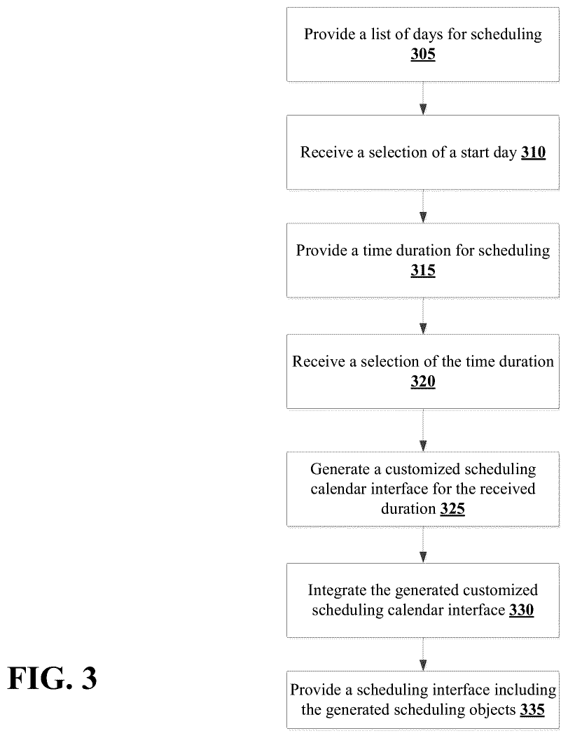

FIG. 1 shows a network environment 100 with an example of an schedule management computing apparatus 14. Briefly, the schedule management computing apparatus 14 generates graphical user interfaces for display on a plurality of staff computing devices 12(1)-12(n) based on content provided by a plurality of data servers 16(1)-16(n). Assume that a user at one of the staff computing devices 12(1)-12(n) wishes to create a customized calendar in the graphical user interface. The user selects the starting day of the work week and the duration of the work week in a form that is provided by the schedule management computing apparatus. Based on the starting day of the work week and the duration, a customized calendar is created on the graphical user interface. An administrator, by way of example, can quickly view the created customized calendar to better understand the staffing needs of the organization as opposed to navigating through a conventional calendar. This process is described in further detail below with respect to FIGS. 3-8.

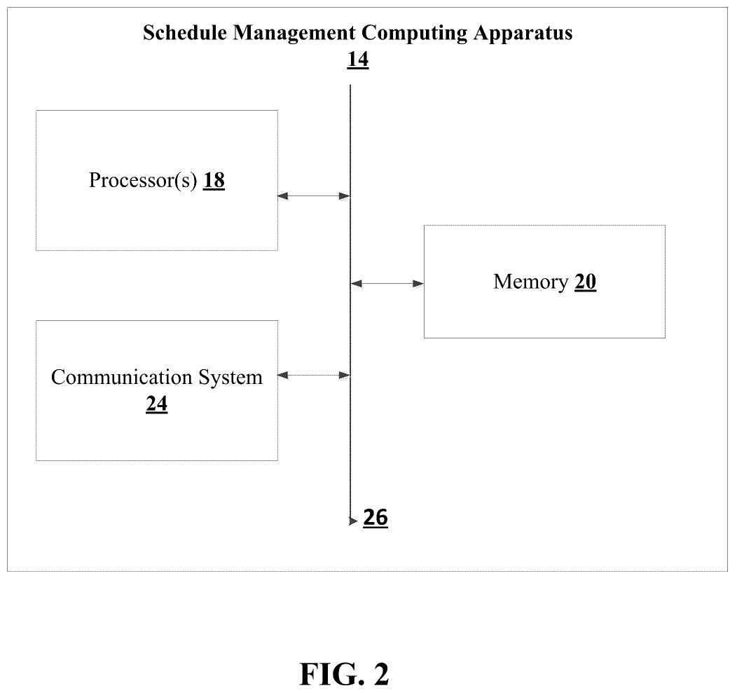

A network environment 100 with an example of a schedule management computing apparatus 14 is illustrated in FIGS. 1-2. In this particular example, the network environment 100 includes a plurality of staff computing devices 12(1)-12(n), the schedule management computing apparatus 14, and a plurality of data servers 16(1)-16(n) connected through a communication network 30, although the environment could include other types and numbers of systems, devices such as server devices, components, and/or other elements as is generally known in the art and will not be illustrated or described herein. This technology provides a number of advantages including providing methods, non-transitory computer readable medium, and apparatuses that creates a customized scheduling calendar.

Referring more specifically to FIGS. 1-2, the schedule management computing apparatus 14 is programmed to assist with creating a customized scheduling calendar, although the apparatus can perform other types and/or numbers of functions or other operations and this technology can be utilized with other types of claims. In this particular example, the schedule management computing apparatus 14 includes a processor 18, a memory 20, and a communication system 24 which are coupled together by a bus 26, although the schedule management computing apparatus 14 may comprise other types and/or numbers of physical and/or virtual systems, devices, components, and/or other elements in other configurations.

The processor 18 in the schedule management computing apparatus 14 may execute one or more programmed instructions stored in the memory 20 for creating a customized scheduling calendar as illustrated and described in the examples herein, although other types and numbers of functions and/or other operations can be performed. The processor 18 in the schedule management computing apparatus 14 may include one or more central processing units and/or general purpose processors with one or more processing cores, for example.

The memory 20 in the schedule management computing apparatus 14 stores the programmed instructions and other data for one or more aspects of the present technology as described and illustrated herein, although some or all of the programmed instructions could be stored and executed elsewhere. A variety of different types of memory storage devices, such as a random access memory (RAM) or a read only memory (ROM) in the system or a floppy disk, hard disk, CD ROM, DVD ROM, or other computer readable medium which is read from and written to by a magnetic, optical, or other reading and writing system that is coupled to the processor 18, can be used for the memory 20.

The communication system 24 in the schedule management computing apparatus 14 operatively couples and communicates between plurality of staff computing devices 12(1)-12(n), which are all coupled together by one or more of the communication networks 30, although other types and numbers of communication networks or systems with other types and numbers of connections and configurations to other devices and elements. By way of example only, the communication network 30 can use TCP/IP over Ethernet and industry-standard protocols, including NFS, CIFS, SOAP, XML, LDAP, SCSI, and SNMP, although other types and numbers of communication networks, can be used. The communication network 30 in this example may employ any suitable interface mechanisms and network communication technologies, including, for example, any local area network, any wide area network (e.g., Internet), teletraffic in any suitable form (e.g., voice, modem, and the like), Public Switched Telephone Network (PSTNs), Ethernet-based Packet Data Networks (PDNs), and any combinations thereof and the like.

In this particular example, each of the staff computing devices 12(1)-12(n) may request or view the customized scheduling calendar created by the schedule management computing apparatus 14, although the staff computing devices 12(1)-12(n) can interact with the schedule management computing apparatus 14 for other purposes. Each of the staff computing devices 12(1)-12(n) may include a processor, a memory, user input device, such as a keyboard, mouse, and/or interactive display screen by way of example only, a display device, and a communication interface, which are coupled together by a bus or other link, although each may have other types and/or numbers of other systems, devices, components, and/or other elements.

Each of the data servers 16(1)-16(n) includes a central processing unit (CPU) or processor, a memory, and a communication system, which are coupled together by a bus or other link, although other numbers and/or types of network devices could be used. Generally, the data servers 16(1)-16(n) provides the data necessary to create the customized scheduling calendar to the schedule management computing apparatus 14, via the communication network 30 according to the HTTP-based application RFC protocol or the CIFS or NFS protocol in this example, but the principles discussed herein are not limited to this example and can include other application protocols. A series of applications may run on the data servers 16(1)-16(n) that allows the transmission of data requested by the staff computing devices 12(1)-12(n), or the schedule management computing apparatus 14. It is to be understood that the data servers 16(1)-16(n) may be hardware or software or may represent a system with multiple external resource servers, which may include internal or external networks. In this example the data servers 16(1)-16(n) may be any version of Microsoft® IIS servers or Apache® servers, although other types of servers may be used.

Although the exemplary network environment 100 with the schedule management computing apparatus 14, the staff computing devices 12(1)-12(n), and the data servers 16(1)-16(n) is described and illustrated herein, other types and numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s). The disclosed technology can be implemented as module or components of another application. Further, the disclosed technology can be implemented as operating system extensions, module, plugins, or the like. The disclosed technology can be implemented as module or components of another application. Further, the disclosed technology can be implemented as operating system extensions, module, plugins, or the like. Even further, the disclosed technology may be operative in a cloud-based computing environment. The disclosed technology can be executed within virtual machine(s) or virtual server(s) that may be managed in a cloud-based computing environment. Also, the disclosed technology, including the schedule management computing apparatus 14 itself, may be located in virtual server(s) running in a cloud-based computing environment rather than being tied to one or more specific physical network computing devices. Also, the disclosed technology may be running in one or more virtual machines (VMs) executing on the schedule management computing apparatus 14. Additionally, in at least one of the various embodiments, virtual machine(s) running on the schedule management computing apparatus 14 may be managed or supervised by a hypervisor.

Although the schedule management computing apparatus 14 is illustrated as a single device, one or more actions of the schedule management computing apparatus 14 may be distributed across one or more distinct computing devices. Moreover, the schedule management computing apparatus 14 is not limited to a particular configuration. Thus, the schedule management computing apparatus 14 may contain a plurality of computing devices that operate using a master/slave approach, whereby one of the computing device of the schedule management computing apparatus 14 operates to manage and/or otherwise coordinate operations of the other network computing devices. The schedule management computing apparatus 14 may operate as a plurality of network computing devices within cluster architecture, a peer-to peer architecture, virtual machines, or within a cloud architecture.

Thus, the technology disclosed herein is not to be construed as being limited to a single environment and other configurations and architectures are also envisaged. For example, the schedule management computing apparatus 14 in FIG. 1 can operate within other computing devices (not shown) rather than as a stand-alone computing device.

While the schedule management computing apparatus 14 is illustrated in this example as including a single device, the schedule management computing apparatus 14 in other examples can include a plurality of devices or blades each with one or more processors, each processor with one or more processing cores that implement one or more steps of this technology. In these examples, one or more of the devices can have a dedicated communication interface or memory. Alternatively, one or more of the devices can utilize the memory, communication interface, or other hardware or software components of one or more other communicably coupled devices. Additionally, one or more of the devices that together comprise schedule management computing apparatus 14 in other examples can be standalone devices or integrated with one or more other devices or applications, for example. Moreover, one or more of the devices of the schedule management computing apparatus 14 in these examples can be in a same or a different communication network including one or more public, private, virtual or cloud networks, for example.

One or more of the components depicted in the network environment 100, such as the schedule management computing apparatus 14, for example, may be configured to operate as virtual instances on the same physical machine. In other words, the schedule management computing apparatus 14 illustrated in FIG. 1 may operate on the same physical device rather than as separate devices communicating through a network as depicted in FIG. 1.

In addition, two or more computing systems or devices can be substituted for any one of the systems or devices in any example. Accordingly, principles and advantages of distributed processing, such as redundancy and replication also can be implemented, as desired, to increase the robustness and performance of the devices, apparatuses, and systems of the examples. The examples may also be implemented on computer system(s) that extend across any suitable network using any suitable interface mechanisms and traffic technologies, including, by way of example, only teletraffic in any suitable form (e.g., voice and modem), wireless traffic media, wireless traffic networks, cellular traffic networks, G3 traffic networks, Public Switched Telephone Network (PSTNs), Packet Data Networks (PDNs), the Internet, intranets, and combinations thereof.

The examples also may be embodied as a non-transitory computer readable medium having instructions stored thereon for one or more aspects of the present technology as described and illustrated by way of the examples herein, as described herein, which when executed by the processor, cause the processor to carry out the steps necessary to implement the methods of this technology as described and illustrated with the examples herein.

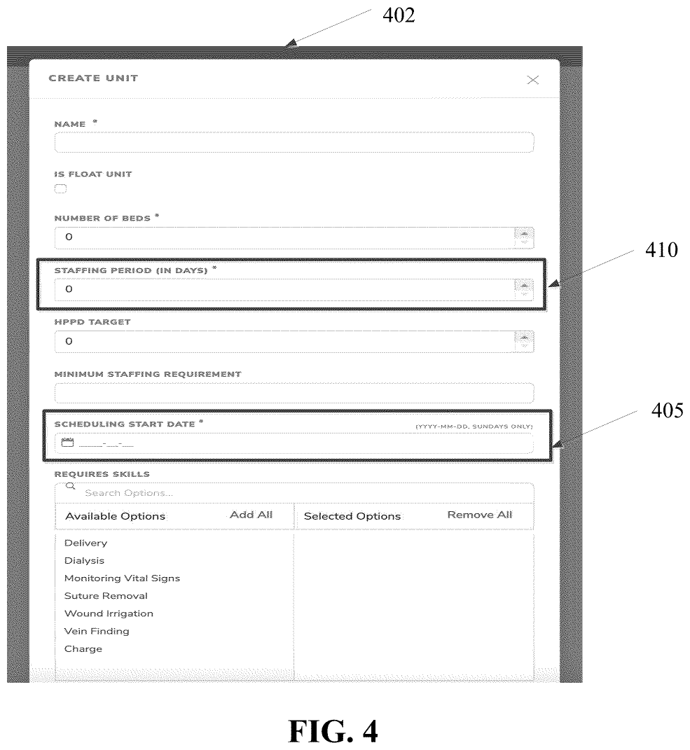

An example of a method for creating a customized scheduling calendar will now be described with reference to FIGS. 1-8. The exemplary method begins with FIG. 3 at step 305, where the schedule management computing apparatus 14 provides a list of days for scheduling to one of the staff computing devices 12(1)-12(n), although the schedule management computing apparatus 14 can provide other types or amounts of information to the staff computing devices 12(1)-12(n). By way of example, the schedule management computing apparatus 14 can provide a form 402 that includes the list of days or a start date 405 as illustrated in FIG. 4 for which the customized calendar is to be created, although the schedule management computing apparatus 14 can provide list of days in other forms.

In step 310, the schedule management computing apparatus 14 receives a selection of the start date from one of the staff computing devices 12(1)-12(n), although the schedule management computing apparatus 14 can receive other types or amounts of information necessary to create the customized scheduling calendar from the staff computing devices 12(1)-12(n).

In step 315, the schedule management computing apparatus 14 provides an option to select the time duration for which the customized calendar is required to be generated to one of the staff computing devices 12(1)-12(n). By way of example, the schedule management computing apparatus 14 can provide the form 402 illustrated in FIG. 4 that includes the staffing period field 410 to one of the staff computing devices 12(1)-12(n), although the schedule management computing apparatus 14 can provide the option to select the time duration using other techniques.

In step 320, the schedule management computing apparatus 14 receives a selection of the time duration from one of the staff computing devices 12(1)-12(n), although the schedule management computing apparatus 14 can receive other types or amounts of information necessary to generate the customized calendar from the staff computing devices 12(1)-12(n).

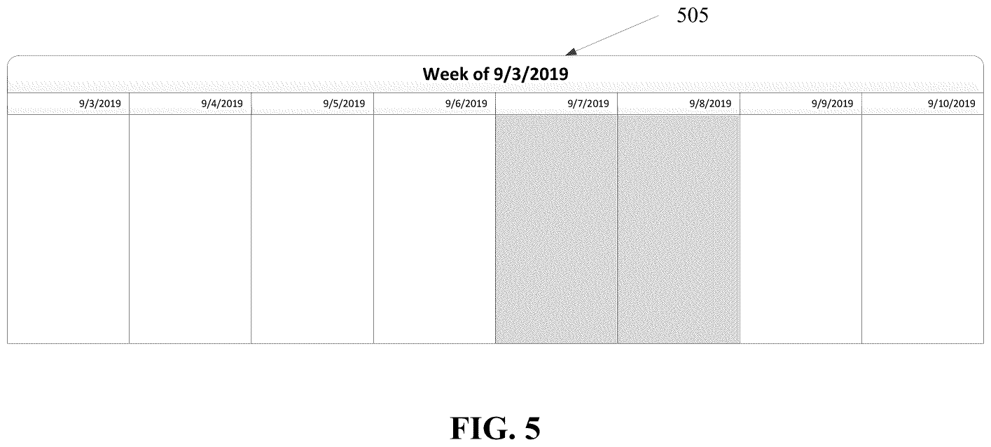

In step 325, the schedule management computing apparatus 14 generates a customized scheduling calendar interface for the start day received in step 310 and the time duration received in step 320, although the schedule management computing apparatus 14 can generate the customized scheduling calendar using other types or amounts of information. By way of example, if the schedule management computing apparatus 14 receives the start day as Tuesday Sep. 3, 2019 and the duration as eight days, then the schedule management computing apparatus 14 generates the customized calendar interface 505 illustrated in FIG. 5. By generating a customizable calendar interface with a start day and duration received from the staff computing devices 12(1)-12(n), the disclosed technology is able to provide flexibility to user to generate a calendar that is configured to their schedule as opposed to a conventional calendar that is not customizable. In one example, the schedule management computing apparatus 14 can automatically delete the customized calendar interface after the expiration of the received time duration. In another example, the schedule management computing apparatus 14 can store the generated customized calendar interface within the memory 20 or at the data servers 16(1)-16(n), even after the expiration of the time duration.

In step 330, the schedule management computing apparatus 14 integrates the generated customized schedule calendar interface with a schedule management application to allow data to be exchanged between the generated customized schedule calendar interface and the schedule management application. By integrating the customized schedule calendar interface with the schedule management application, the disclosed technology provides flexibility to the users to be able use the customized calendar along with different software applications.

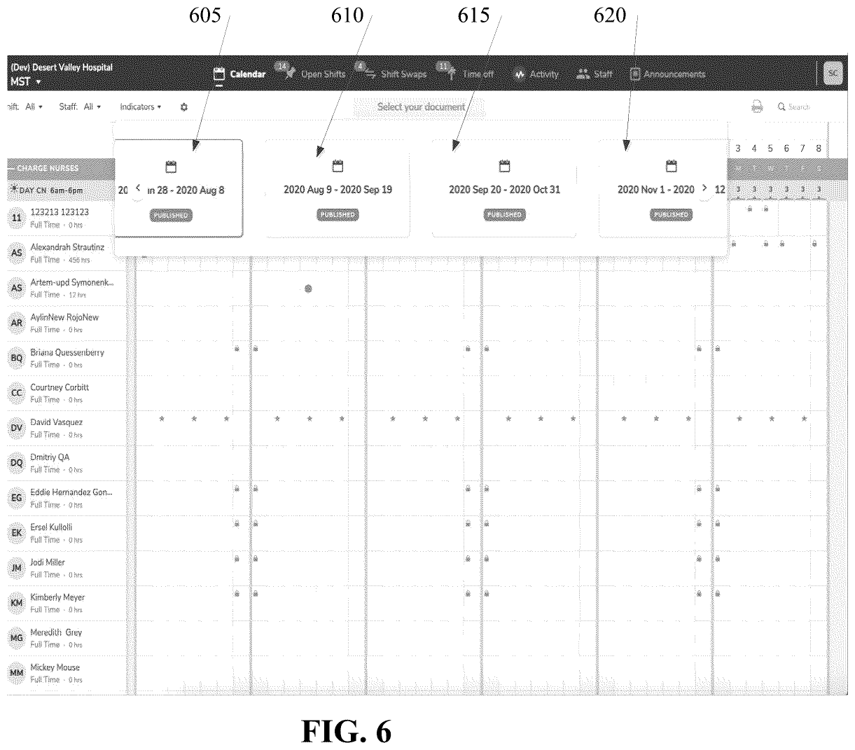

In step 335, the schedule management computing apparatus 14 provides the generated customized scheduling calendar interface to the requesting one of the staff computing devices 12(1)-12(n), although the schedule management computing apparatus 14 can provide the generated customized scheduling calendar to other devices. By way of example, FIG. 6 illustrates multiple customized calendars including a first customized calendar 605, a second customized calendar 610, a third customized calendar 615, and fourth customized calendar 620 that are generated for different time periods and start days. In another example, the schedule management computing apparatus 14 can provide the generated customized scheduling calendar interface integrated with the scheduling management application interface to the requesting one of the staff computing devices 12(1)-12(n).

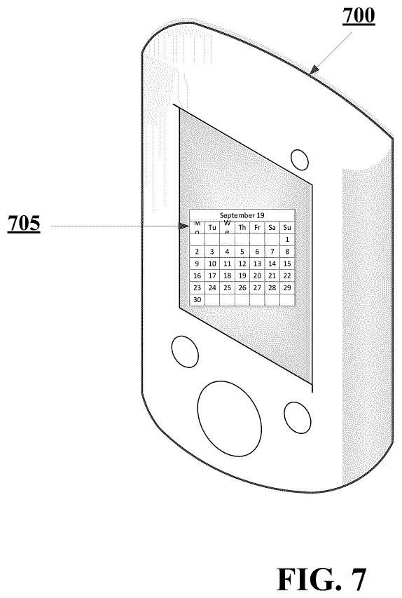

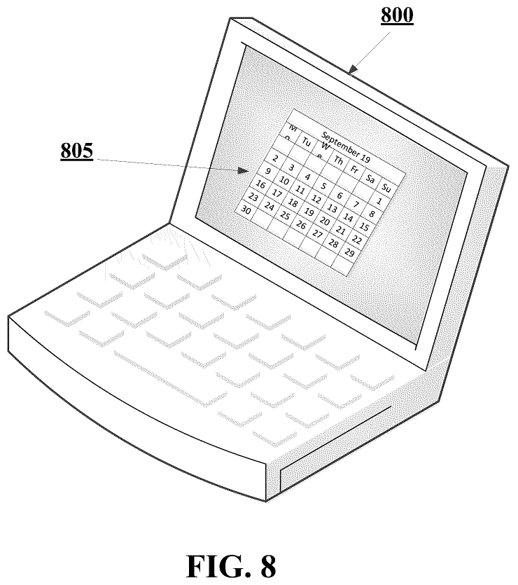

In another example, the schedule management computing apparatus 14 can generate the customized scheduling calendar based on the data associated with the requesting one of the staff computing devices 12(1)-12(n). In this example, the schedule management computing apparatus 14 can identify a type of the requesting one of the staff computing devices 12(1)-12(n). By way of example, types of staff computing devices 12(1)-12(n) can include a mobile device, a tablet, a smart phone, although types of staff computing devices 12(1)-12(n) can include other types of devices. Additionally, the schedule management computing apparatus 14 can identify the technical configuration of the requesting staff computing devices 12(1)-12(n). By way of example, the technical configuration can include data such as software version of the operation system executing on the requesting staff computing devices 12(1)-12(n), dimension of the display unit or the screen of the requesting one of the staff computing devices 12(1)-12(n), a screen resolution of the requesting one of the staff computing devices 12(1)-12(n), although the technical configuration can include other types of data such as type of processor, memory of the requesting one of the staff computing devices 12(1)-12(n). After receiving the selection of the start day as illustrated in step 310 and receiving the selection of the time duration as illustrated in step 320, the schedule management computing apparatus 14 can then generate the customized calendar schedule exclusively for the requesting one of the staff computing devices 12(1)-12(n). By way of example, if the requesting one of staff computing devices 12(1)-12(n) is a smart phone 700 as illustrated in FIG. 7, then the customized scheduling calendar 705 is generated by the schedule management computing apparatus 14 such that it can be easily viewable on the screen of the smart phone 700. In another example, if the requesting one of the staff computing devices 12(1)-12(n) is a laptop 800 (FIG. 8), then the schedule management computing apparatus 14 particularly generates the customized scheduling calendar 805 (FIG. 8) for the start day and the duration that was received in step 310 and 320 respectively. By considering the type and the technical configuration of the requesting staff computing device, the disclosed technology is able to generate an adaptable customized scheduling interface that can be conveniently viewed on different devices.

It should be noted that the computing architecture discussed above with respect to FIGS. 1-3 is merely one example of the architecture that can be used to perform the techniques described herein. For example, the discussion presented above assumes a “cloud” based implementation, where processing is performed primarily by a schedule management computing apparatus that is remote from the user computing device. However, in other embodiments, some or all of the functionality performed by the schedule management computing apparatus may be performed locally by the user computing device. In other embodiments a combination of local and remote processing can be employed. For example, content selections can be cached locally at the staff computing device, and periodically synched with a cache at the schedule management computing apparatus.

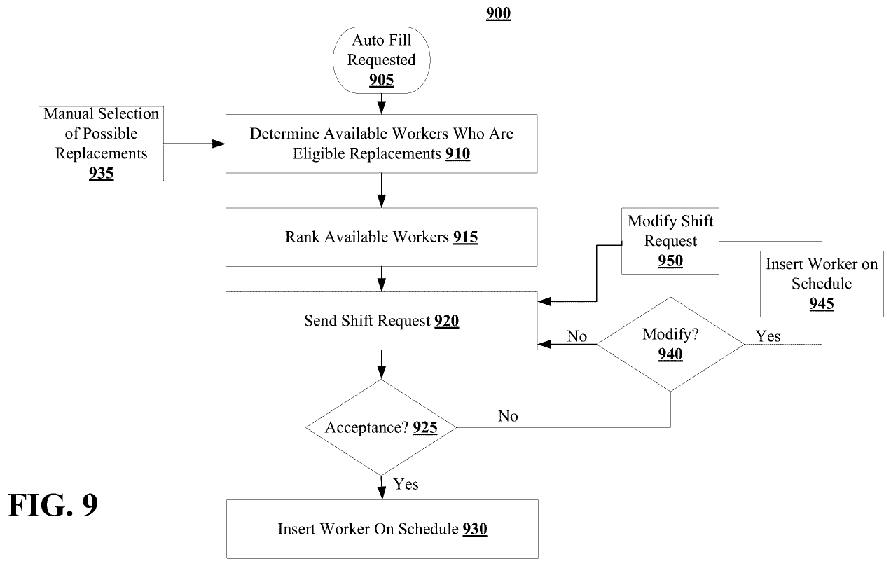

FIG. 9 is a flowchart of an example shift scheduling method 900 for shift scheduling according to embodiments described herein. The method 900 begins at step 905 when an automatic shift fill request is received at a computing system (referred to herein as the “shift scheduling computing system”) from a user's computing device. The user may be a worker, supervisor, or other user within an organization needing to schedule or modify a shift. The user's computing device may be, for example, a mobile phone, a desktop computer, server, or other similar device.

In some embodiments, the user's level of control over the shift information may vary based on the user's position within the organization. For example, a worker may only have permission to edit shift information for the worker (and not other workers). A supervisor may have permission to edit shift information for the supervisor as well as one or more workers. In some embodiments, the permissions or access to the shift information can be custom configured by the supervisor or other supervisory personnel. For example, the list of the workers for whom a supervisor can adjust shifts can be increased or decreased as necessary by the supervisor's organization. In other embodiments, a worker may be granted permission to modify the worker's scheduled shift to address emergencies or other events that may occur prior to or during the shift. For example, a worker might need to go home halfway through the worker's shift because the worker is sick or needs to pick up a sick child from daycare/school.

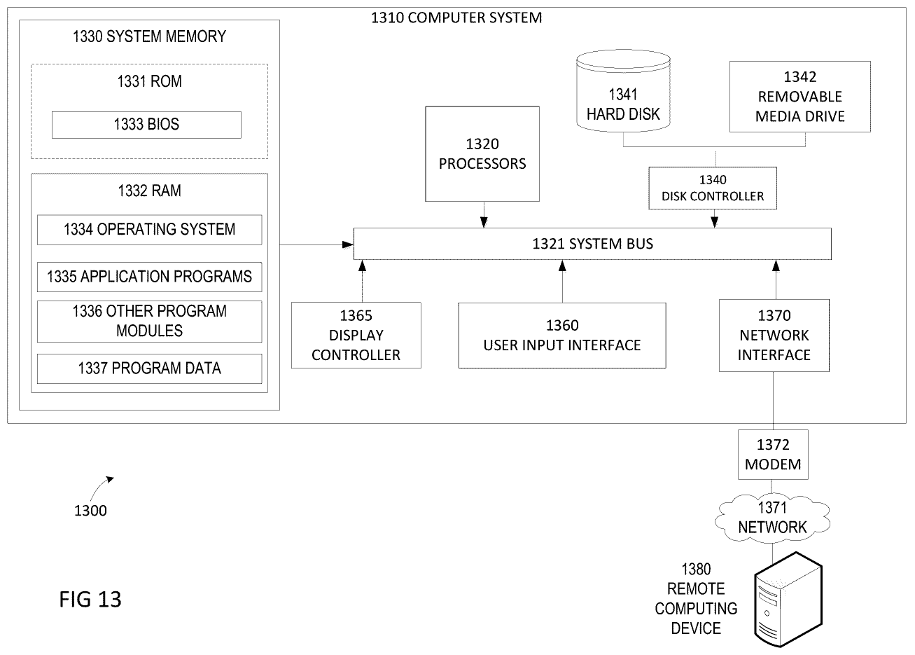

Continuing with reference to FIG. 9, at step 910, the shift scheduling computing system receives a shift fill request and determines the available workers who are eligible replacements. In some embodiments, the shift scheduling computing system accesses personnel data stored in memory, such as on hard disk or removable media drive (see, e.g., FIG. 13). The personnel data may include, for example, the registered workforce, and associated with each worker is data comprising the worker's current working schedule, qualifications, certifications, training, experience, work preferences, performance reviews, and the like.

At step 910, the shift scheduling computing system receives the personnel data (e.g., from hard disk or removable media drive) and determines a list of workers who are available to cover (i.e., work) the shift request. Next, at step 915, the shift scheduling computing system ranks the available workers. In an embodiment, the ranking algorithm is configurable to customize the weight assigned to specific factors used to rank available workers. For example, it may be desirous to have the most qualified and experienced workers cover the shift, and thus, experience would be weighted more heavily than other factors. In another example, it may be desirous to have the least experienced workers cover the shift so that they can build experience. In this example, “experience” would be weighted more heavily than other factors, but the amount of experience is configurable to set the least amount of experience to be the most valuable. Any number of weighting algorithms can be used to weigh the various criteria associated with each available worker to arrive at a ranked listing of workers in step 915.

In an embodiment, at step 935, a manual selection of possible replacements can take place. In an embodiment, when a worker cannot complete a shift, the worker may be prompted to offer a replacement worker. For example, the worker who cannot complete a shift may have a co-worker who can and wants to complete the shift. At step 935, a prompt, for example, on the GUI interface will enable the worker to supply the identity of the replacement worker. In some embodiments, the replacement worker may be scheduled to work with no other analysis. In other embodiments, the worker will be evaluated as described below with other workers, but the worker identified in step 935 may be weighted such that the worker is more likely to be selected, but still without certainty that the worker named in step 935 will actually be the replacement worker. In an embodiment, the suggested replacement worker at step 935 will still be evaluated for availability, qualifications, etc. for working as the replacement because the suggested person in step 935 may not have the required availability or not be qualified to work the worker's shift.

Next, at step 920, the work request is communicated to the highest ranked worker. In an embodiment, the shift request may be communicated automatically via an email, text, voice, or other form of communication. In an embodiment, an email or text may contain a link that enables the recipient to indicate acceptance, modification, or rejection of the shift request as discussed below.

At step 925, the recipient accepts or rejects the shift request. If the recipient accepts the shift request, then at step 930, the recipient worker is assigned the shift. If the recipient rejects the shift, then at step 940, the recipient may select to work a portion of the shift request. For example, if the shift request were four hours long, the recipient might select to work the first hour. If the recipient does not wish to modify the shift request, then the unmodified shift request is resent at step 920 to the next highest ranked available worker. This process continues until the shift request is filled. If the recipient modifies the shift request by accepting part of the shift request, then at step 945, the recipient worker is inserted on the work schedule for the selected time. At step 950, the shift request is modified to reflect the unclaimed time, and at step 920, the modified shift request is sent to the next highest ranked available worker until all of the shift time is accepted or there are no more available workers.

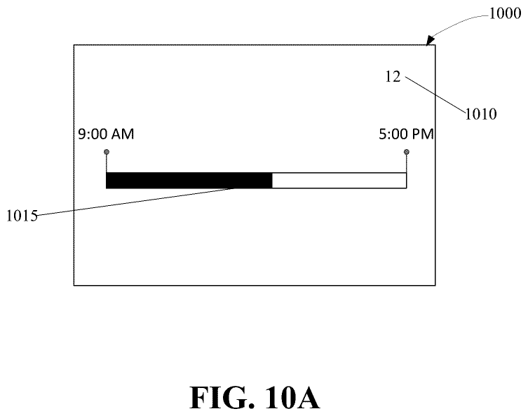

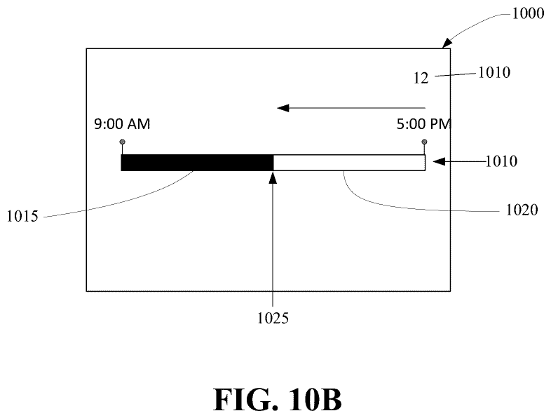

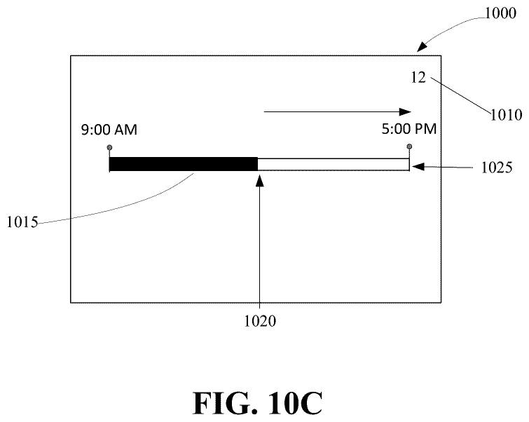

FIGS. 10A, 10B, and 10C depict exemplary diagrams of a GUI 1000 with a shift indicator according to embodiments described herein. FIG. 10A depicts an exemplary diagram of a shift indicator 1015 on date 1010 that is viewed on the GUI of the user's computing device. In an embodiment, a shift indicator 1015 may be represented by a linear indicator. Shift indicator 1015 may be configured to represent a shift, multiple shifts, units of time within a single shift, or the like. As will be understood by persons of ordinary skill in the art, any type of suitable indicator could be used to represent a duration of a shift or shifts. For example, a shift indicator could be any geometric shape, a graphical image, an animated image such as an hour glass, or the like.

In an embodiment, the shift indicator 1010 can be manipulated by the worker on the user's computing device. For example, if the worker needs to shorten the shift, then, as shown in FIG. 10B, shift indicator 1010 is shortened from the original shift length 1020 to the shorter shift length 1025. In an example in which the worker needs to lengthen a shift, as shown in FIG. 10C, the shift indicator 1010 is manipulated from the original time 1020 to the new longer time 1025. Alternatively, the shift can be manipulated from any user input rather than through the shift indicator 1015 on a GUI interface 1000.

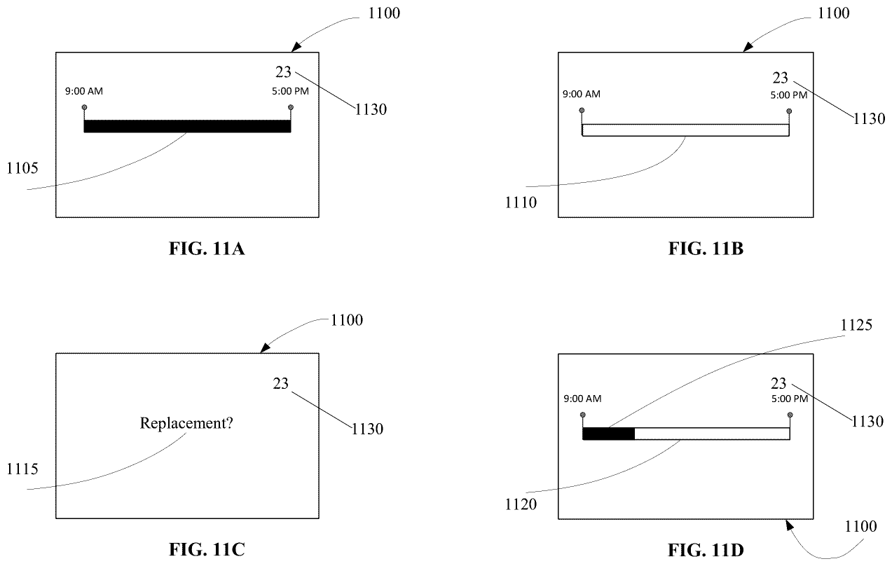

In addition to shortening (or lengthening) a shift, a shift may also be deleted by a worker, and the shift will need to be replaced by another worker. FIGS. 11A, 11B, 11C, and 11D depict exemplary diagrams of a GUI 1100 for replacing a shift according to embodiments described herein. FIG. 11A discloses shift indicator 1105 on date 1130 in a GUI. In FIG. 11B, shift indicator 1110 appears as a dashed line to indicate that the shift indicator 1110 has been manipulated to indicate that the worker will not work any of the assigned shift time. Alternatively, shift indicator 1110 can exist in any form that provides a visual indicator to a user that the shift has been deleted.

FIG. 11C discloses an exemplary GUI 1100 interface that may be displayed as a result of a shift indicator being manipulated to represent that scheduled hours will not be worked. A prompt 1115 may appear to ask if a replacement worker is needed on date 1130. A user such as a worker or supervisor receiving the prompt may, for example, have a number of options. For example, a response indicating “yes” or “no” to needing a replacement can be received. As another example, a follow-on prompt may be offered in the instance a replacement is needed that asks if there is a suggested replacement worker that should be considered.

FIG. 11D is an exemplary GUI 1100 displaying the progress in finding a replacement worker(s). In FIG. 11D, the progress bar indicates with a solid color 1125 that a replacement has been found for the portion of the work schedule represented by the solid color 1125. The striped portion 1120 of the progress bar indicates that replacements have not been found for the remaining of the scheduled time on the date 1130. In an embodiment, the progress for finding one or more replacements could be represented by any suitable graphic, including a list of who is scheduled to be the replacement worker(s).

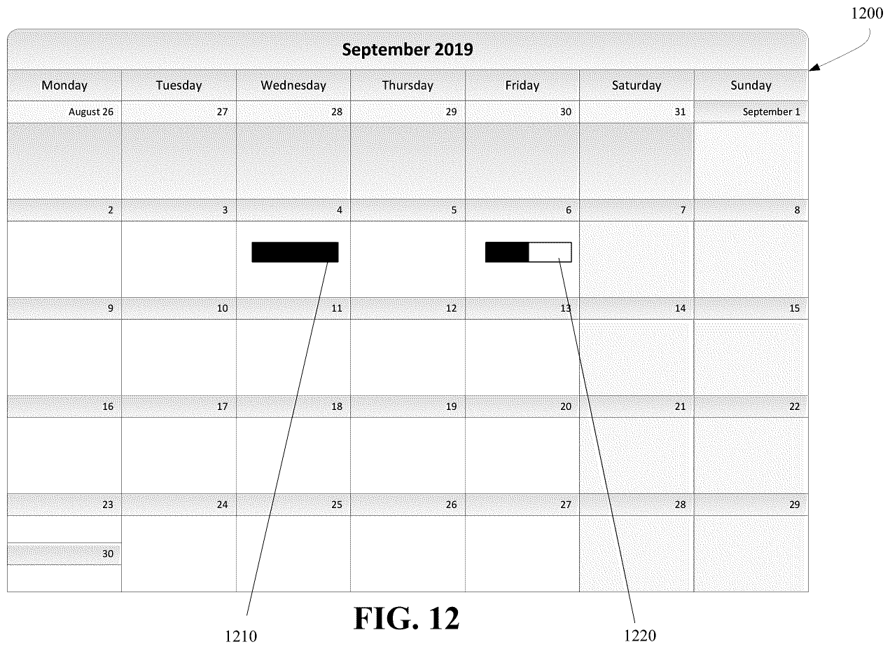

FIG. 12 depicts an exemplary diagram of a GUI calendar view according to embodiments described herein. Calendar 1200 is a monthly view, but in other embodiments, the calendar may comprise any view such as yearly, quarterly, weekly, daily, etc. In an embodiment, the calendar 1200 may be personalized for a worker. That is, calendar 1200 will display the work schedule for a specific worker. In another embodiment, the calendar 1200 may display work schedules for a manager, and therefore, the calendar 1200 will show many work schedules.

In an embodiment, FIG. 12 discloses a calendar view of days for scheduling determined in accordance with the steps disclosed in FIG. 3. The customized start day for each week in FIG. 12 is Monday. Combinations of the embodiments disclosed herein, such as those in FIGS. 3 and 9 may be implemented by those skilled in the art, without departing from the scope of the invention.

As shown in FIG. 12, calendar 1200 is an exemplary embodiment of a monthly calendar for a worker. The worker has two shift indicators 1210 and 1220 scheduled for the week of September 2nd. In an embodiment, shift indicator 1210 indicates that the worker is able to work the entire shift because it is filled in. In other embodiments, the shift indicators can take any form that indicates the shift and the amount of the shift that is or can be worked. Shift indicator 1220 indicates that the worker can only work approximately half of the assigned shift. As described herein, the shift indicator 1220 may be adjusted by the worker or the supervisor to indicate that the shift is not complete. In an embodiment, when shift indicator 1220 is adjusted to the level shown in FIG. 12, it initiates the systems, methods, and apparatuses disclosed herein to autofill the portion of the shift that the worker does not work with the best available worker(s).

FIG. 13 illustrates an exemplary computing environment 1300 within which the techniques described herein may be implemented. The computing environment 1300 includes computer system 1310, which is one example of a computing system upon which embodiments of the invention may be implemented. Computers and computing environments, such as computer system 1310 and computing environment 1300, are known to those of skill in the art and thus are described briefly herein. Within the context of the present invention, the computer system 1310 may be used to implement the shift scheduling computing system, while the remote computing device 1380 (described in further detail below) may be used to implement the user's computing device.

As shown in FIG. 13, the computer system 1310 may include a communication mechanism such as a bus 1321 or other communication mechanism for communicating information within the computer system 1310. The computer system 1310 further includes one or more processors 1320 coupled with the bus 1321 for processing the information. The processors 1320 may include one or more central processing units (CPUs), graphical processing units (GPUs), or any other processor known in the art.

The computer system 1310 also includes a system memory 1330 coupled to the bus 1321 for storing information and instructions to be executed by processors 1320. The system memory 1330 may include computer readable storage media in the form of volatile and/or nonvolatile memory, such as read only memory (ROM) 1331 and/or random access memory (RAM) 1332. The system memory RAM 1332 may include other dynamic storage device(s) (e.g., dynamic RAM, static RAM, and synchronous DRAM). The system memory ROM 1331 may include other static storage device(s) (e.g., programmable ROM, erasable PROM, and electrically erasable PROM). In addition, the system memory 1330 may be used for storing temporary variables or other intermediate information during the execution of instructions by the processors 1320. A basic input/output system (BIOS) 1333 contains the basic routines that help to transfer information between elements within computer system 1310, such as during start-up, may be stored in ROM 1331. RAM 1332 may contain data and/or program modules that are immediately accessible to and/or presently being operated on by the processors 1320. System memory 1330 may additionally include, for example, operating system 1334, application programs 1335, other program modules 1336 and program data 1337. The application programs 1335 may include, for example, the one or more executable applications corresponding to a Cloud Service (not shown).

The computer system 1310 also includes a disk controller 1340 coupled to the bus 1321 to control one or more storage devices for storing information and instructions, such as a hard disk 1341 and a removable media drive 1342 (e.g., compact disc drive, solid state drive, etc.). The storage devices may be added to the computer system 1310 using an appropriate device interface (e.g., a small computer system interface (SCSI), integrated device electronics (IDE), Universal Serial Bus (USB), or FireWire).

The computer system 1310 may also include a display controller 1365 coupled to the bus 1321 to control a display, such as a touchscreen display for displaying a GUI to a computer user. The computer system includes an input interface 1360 for interacting with a computer user via the GUI and providing information to the processors 1320. In some embodiments, the computer system 1310 may include additional or alternative displays and utilize input devices such as a keyboard and/or a mouse (not shown in FIG. 13) to interact with the user.

The computer system 1310 may perform a portion or all of the processing steps of embodiments of the invention in response to the processors 1320 executing one or more sequences of one or more instructions contained in a memory, such as the system memory 1330. Such instructions may be read into the system memory 1330 from another computer readable medium, such as a hard disk 1341 or a removable media drive 1342. The hard disk 1341 may contain one or more datastores and data files used by embodiments of the present invention. Datastore contents and data files may be encrypted to improve security. The processors 1320 may also be employed in a multi-processing arrangement to execute the one or more sequences of instructions contained in system memory 1330. In alternative embodiments, hard-wired circuitry may be used in place of or in combination with software instructions. Thus, embodiments are not limited to any specific combination of hardware circuitry and software.

As stated above, the computer system 1310 may include at least one computer readable medium or memory for holding instructions programmed according to embodiments of the invention and for containing data structures, tables, records, or other data described herein. The term “computer readable medium” as used herein refers to any medium that participates in providing instructions to the processor 1320 for execution. A computer readable medium may take many forms including, but not limited to, non-volatile media, volatile media, and transmission media. Non-limiting examples of non-volatile media include optical disks, solid state drives, magnetic disks, and magneto-optical disks, such as hard disk 1341 or removable media drive 1342. Non-limiting examples of volatile media include dynamic memory, such as system memory 1330. Non-limiting examples of transmission media include coaxial cables, copper wire, and fiber optics, including the wires that make up the bus 1321. Transmission media may also take the form of acoustic or light waves, such as those generated during radio wave and infrared data communications.

When used in a networking environment, computer system 1310 may include modem 1372 for establishing communications with a remote computing system over a network 1371, such as the Internet. Modem 1372 may be connected to bus 1321 via user network interface 1370, or via another appropriate mechanism.

Network 1371 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 1310 and other computers. The network 1371 may be wired, wireless or a combination thereof. Wired connections may be implemented using Ethernet, Universal Serial Bus (USB), RJ-11 or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 1371.

The embodiments of the present disclosure may be implemented with any combination of hardware and software. In addition, the embodiments of the present disclosure may be included in an article of manufacture (e.g., one or more computer program products) having, for example, computer-readable, non-transitory media. The media has embodied therein, for instance, computer readable program code for providing and facilitating the mechanisms of the embodiments of the present disclosure. The article of manufacture can be included as part of a computer system or sold separately.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Unless stated otherwise as apparent from the following discussion, it will be appreciated that terms such as “applying,” “generating,” “identifying,” “determining,” “processing,” “computing,” “selecting,” or the like may refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices. Embodiments of the methods described herein may be implemented using computer software. If written in a programming language conforming to a recognized standard, sequences of instructions designed to implement the methods can be compiled for execution on a variety of hardware platforms and for interface to a variety of operating systems. In addition, embodiments of the present invention are not described with reference to any particular programming language. It will be appreciated that a variety of programming languages may be used to implement embodiments of the present invention.

A “graphical user interface” (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112(f) the element is expressly recited using the phrase “means for.”

What is claimed is:

1. A method for scheduling a shift, the method comprising:
receiving a shift request comprising a skill set and shift data;
identifying workers based on the skill set;
determining a ranking based on the shift data of the identified workers;
assigning each identified worker a rank according to the ranking;
sending the shift request to a highest ranked worker; and
outputting to a user interface an identity of the highest ranked worker accepting the shift request.

2. The method of claim 1 further comprising:
when the highest ranked worker declines the shift request, sending the shift request to a next highest ranked worker until the shift request is accepted.

3. The method of claim 1, wherein the shift data comprises one or more of a location, a time, a date, and a duration.

4. The method of claim 1 further comprising a graphical user interface displaying a graphical representation comprising shifts and shift requests.

5. The method of claim 4, wherein the graphical representation is a linear slider manipulated by a user.

6. The method of claim 1, wherein the shift request is received from a supervisor.

7. The method of claim 1, wherein the shift request is received as a result of an original worker declining to work the shift in the shift request.

8. The method of claim 7 further comprising determining the skill set for the shift from the original worker.

9. The method of claim 1 further comprising determining the skill set for the shift from the shift data comprising one or more of a department, a certification, a license, a training, or a skill.

10. The method of claim 1, wherein the identified workers comprise workers selected by a user.

11. A non-transitory computer readable medium having stored thereon instructions for scheduling a shift, comprising executable code, which when executed by at least one processor, cause the processor to:
receive a shift request comprising a skill set and shift data;
identify workers based on the skill set;
determine a ranking based on the shift data of the identified workers;
assign each identified worker a rank according to the ranking;
send the shift request to a highest ranked worker; and
output to a user interface an identity of the highest ranked worker accepting the shift request.

12. The method of claim 11 further comprising:
when the highest ranked worker declines the shift request, send the shift request to a next highest ranked worker until the shift request is accepted.

13. The method of claim 11, wherein the shift data comprises one or more of a location, a time, a date, and a duration.

14. The method of claim 11 comprising a graphical user interface displaying a graphical representation comprising shifts and shift requests.

15. The method of claim 14, wherein the graphical representation is a linear slider manipulated by a user.

16. The method of claim 11, wherein the shift request is received from a supervisor.

17. The method of claim 11, wherein the shift request is received as a result of an original worker declining to work the shift in the shift request.

18. The method of claim 17 further comprising determine the skill set for the shift from the original worker.

19. The method of claim 11 further comprising determining the skill set for the shift from the shift data comprising one or more of a department, a certification, a license, a training, or a skill.

20. A system comprising:
a memory;
a processor in communication with the memory; and
program instructions executable by the processor via the memory to cause the processor to:
receive a shift request comprising a skill set and shift data;
identify workers based on the skill set;
determine a ranking based on the shift data of the identified workers;
assign each identified worker a rank according to the ranking;
send the shift request to a highest ranked worker; and
output to a user interface an identity of the highest ranked worker accepting the shift request.
